(19) United States
(12) Patent Application Publication
(10) Pub. No.: US 2011/0282730 A1
(43) Pub. Date: Nov. 17, 2011

(54) SYSTEM AND METHOD FOR SELECTING AND IMPLEMENTING AN INTERNET ADVERTISING CAMPAIGN

(75) Inventor: Kenneth John Tarmas, Carlsbad, CA (US)

(73) Assignee: AdChoice, Inc.

(21) Appl. No.: 13/103,662

(22) Filed: May 9, 2011

Related U.S. Application Data
(60) Provisional application No. 61/334,539, filed on May 13, 2010.

(51) Int. Cl. G06Q 30/00

(52) U.S. Cl. 705/14.42

(57) ABSTRACT

A system, method and a computer program product for identifying and implementing an optimized Internet advertising campaign provides for selecting a representative sample of Internet-based advertisers in a targeted business category, instrumenting websites of the representative sample of Internet-based advertisers to collect data from desired customer actions generated by a selection of advertising options in the targeted business category, building a database including campaign performance data and a targeting library, analyzing the data to determine relative cost and efficiency of each of the plurality of advertising options in the targeted business category, generating and displaying a selection matrix comparing the relative cost and efficiency of each of the selected advertising options in the targeted business category, and uploading an ad campaign to a selected advertising network.

### CROSS REFERENCE

This application claims the benefit of U.S. Prov. No. 61/334,539, entitled “System and Method for Selecting and Implementing an Internet Advertising Campaign,” filed May 13, 2010, hereby expressly incorporated by reference in its entirety.

### TECHNICAL FIELD

Embodiments of the present invention are related to systems and methods for advertising and, in particular, to systems and methods for selecting and implementing an Internet advertising campaign.

### BACKGROUND

Conventional systems and methods for selecting and implementing optimized Internet advertising campaigns are commonly developed through time-consuming trial and error approaches with uncertain results and no reliable comparative data to evaluate the relative cost and effectiveness of alternative approaches. For a number of reasons, small businesses such as attorneys, doctors, dentists, contractors, retailers and others are especially handicapped by these deficiencies in conventional approaches to the selection and deployment of optimized Internet advertising campaigns. First, small businesses are often confronted with a large number of online advertising alternatives including multiple Internet search engines, Internet yellow-page directories, local and city directories, and trade-specific directories. While the factors determining marketing results are often very similar within a given category of small business such as dentists or contractors, it is difficult for a small business to determine relative suitability or effectiveness of the many alternatives. Small businesses often cannot afford the time and expense required to carry out trial-and-error testing. In addition, the effectiveness of the various alternatives can be affected by a number of factors not readily apparent to the advertiser, such as the geographic location of the business, the population density of their location, and whether their destination website is optimized for internet marketing. Such other factors make it more difficult for businesses to determine which alternative may be most effective for their business. Accurate comparison is further hampered by the lack of standardized empirical data. Specifically, the results achieved by one business using a given alternative cannot always be meaningfully compared to those of another business because the parameters of their advertising campaign (such as the search keywords used or the geographic area targeted) are inconsistent, making comparisons unreliable. Lastly, each of the advertising alternatives reach a limited population of prospective customers in the business' service area, which means that for certain options such as pay per click campaigns, there is a limit to the amount that can be efficiently spent on a given option, but no practical way for an advertiser to determine how to allocate his overall budget in the most efficient way.

### SUMMARY

In one embodiment of the present invention, a method for selecting and implementing Internet advertising campaigns includes selecting a representative sample of Internet-based advertisers in a targeted business category, instrumenting websites of the representative sample of Internet-based advertisers to collect data from desired customer actions generated by a plurality of advertising options in the targeted business category, building a database that includes campaign performance data and a targeting library, analyzing the data to determine the relative cost and efficiency of each of the plurality of advertising options in the targeted business category, and generating and displaying a selection matrix comparing the relative cost and efficiency of each of the plurality of advertising options in the targeted business category.

In one embodiment, instrumenting the websites includes adding tracking code configured to record click, conversion and source data, and adding dynamic number insertion code to the websites to identify and track telephone calls from each of the plurality of advertising options.

In one embodiment, the representative sample of Internet-based advertisers may include a geographically limited sample defined by a ZIP code, a city, a metropolitan area, a state, a national region and the nation.

In one embodiment, the representative sample of Internet-based advertisers may include a geographically limited sample defined by categories of population density such as rural, suburban, and urban.

In one embodiment, analyzing the data includes calculating a mean of means to normalize the weights of the results from each of the plurality of advertising options.

In one embodiment, generating the selection matrix may include, for each of the plurality of advertising options, calculating an expected cost per desired customer action, an expected cost per impression, an expected click-through rate, an expected ratio of actions to clicks or conversion rate, and an expected number of actions per unit time.

In one embodiment, the method may further include as part of the selection matrix a “maximum efficient budget”, which represents the maximum amount that can be cost-effectively spent by an advertiser in an area of given population density for a particular advertising option. The maximum efficient budget is derived based on the amount actually spent with an unlimited budget on each option within each population density category using a standardized campaign settings template that defines campaign characteristics.

In one embodiment, the method may further include providing a web-based user interface (UI) configured to enable a user to compare and select an Internet advertising campaign based on a business category, type of advertising campaign such as search keyword or directory listing, a geographical region, and a population density to target a selected set of potential customers. The web-based user interface (UI) is also configured to display an ad campaign performance comparison, where, for each of the plurality of advertising options, a user is provided with the expected cost per action, the expected cost per impression, the expected click-through rate, the expected conversion rate the expected number of actions per unit time and the expected maximum efficient budget per unit time.

In one embodiment, the method also includes providing a campaign generation form configured to assist creation of an optimized ad campaign. The campaign generation form is provided via a the web-based user interface. The campaign generation form being configured to permit a user to enter campaign parameters including the business category, desired advertising budget, geographic location of the business, services provided by the business, whether the business will utilize an optimized website, and population density in the service area. The method further includes selecting advertising options on a cost-per-action basis and utilizing maximum efficient budget data. The method further includes uploading an ad campaign to one or more advertising networks, where the ad campaign conforms with the campaign parameters defined by the combination of the campaign generation form entries and the standardized campaign targeting settings template.

Other embodiments of the present invention may include systems, articles of manufacture and means for implementing the various embodiments described herein

### BRIEF DESCRIPTION OF THE DRAWINGS

Embodiments of the present invention are illustrated by way of example, and not of limitation, in the figures of the accompanying drawings in which:

FIG. 1 illustrates a system according to one embodiment;

FIG. 2 illustrates instrumenting a website in one embodiment;

FIG. 3 illustrates monitoring of an instrumented website to capture data from a plurality of internet advertising options in one embodiment;

FIG. 4 illustrates the selection of various comparison parameters such as a business category or geographic area for a targeted Internet advertising campaign in one embodiment;

FIG. 5 illustrates a comparative analysis of Internet advertising options in one embodiment;

FIG. 6 illustrates the creation and ordering of an optimized Internet ad campaign in one embodiment;

FIG. 7 illustrates the targeting settings based on customized selection parameters for an optimized Internet advertising campaign containing multiple component ad options in one embodiment;

FIG. 8 illustrates the campaign targeting details for each component ad option, allowing user review and editing of those details in one embodiment;

FIG. 9 illustrates uploading an ad campaign to a selected Internet advertising network in one embodiment;

FIG. 10 is a flowchart illustrating a method according to one embodiment; and

FIG. 11 is a block diagram illustrating a system in one embodiment.

### DETAILED DESCRIPTION

In the following description, numerous specific details are set forth such as examples of specific components, devices, methods, etc., in order to provide a thorough understanding of embodiments of the present invention. It will be apparent to one skilled in the art, however, that these specific details need not be employed to practice embodiments of the present invention. In other instances, well-known materials or methods have not been described in detail in order to avoid unnecessarily obscuring embodiments of the present invention. The term “coupled” as used herein, may mean directly coupled or indirectly coupled through one or more intervening components.

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

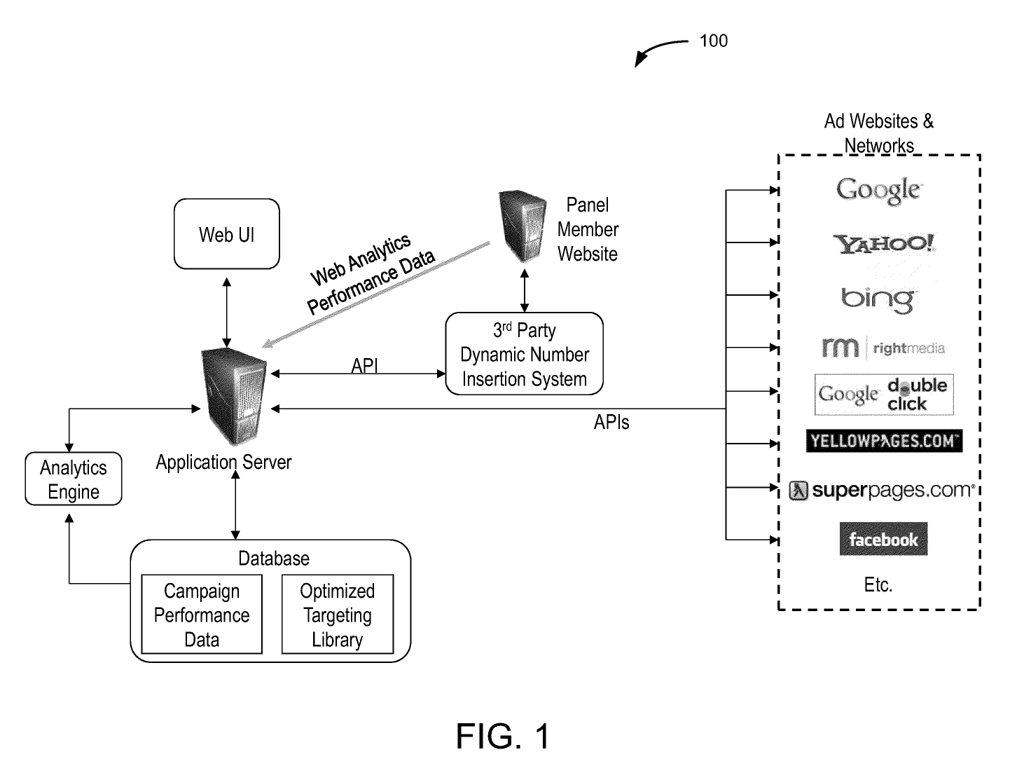

FIG. 1 illustrates a system 100 for developing and deploying an Internet ad campaign in one embodiment of the invention. In FIG. 1, an application server including at least a processor, a memory, a mass storage device and a network interface device is configured to communicate over one or more networks (including, e.g., the Internet) with one or more users through a web-based user interface (UI), with websites operated by panel members comprising representative samples of Internet-based advertisers in a variety of business categories, and with a number of Internet advertising sites and networks such as Google, Yahoo, Bing and others as illustrated, but not limited to, in FIG. 1.

The panel members may be representative of certain geographical areas and demographics defined, for example, by ZIP codes, cities, metropolitan areas, counties, regions, states and the like. The panels may be selected by any statistically valid means such as random sampling or parametric sampling as is known in the art. Potential panel members may be asked to grant access to their websites, for the purpose of instrumenting the sites as described below, in exchange for a fee, for example, or for subsequent access to the results of ad campaign performance data developed by the system as described below.

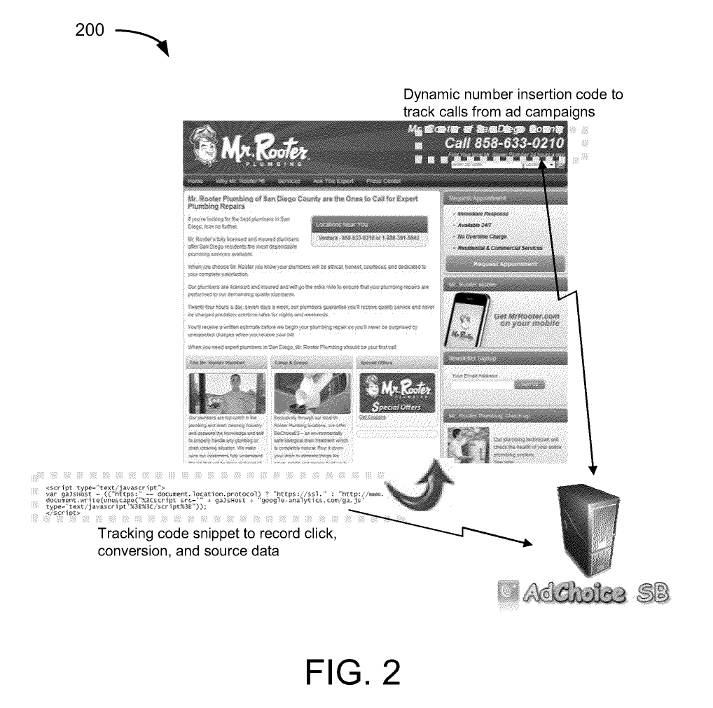

Once access is granted, the websites of the panel members may be instrumented by installing code on the website pages to collect and forward data regarding the efficacy of different advertising campaigns and options and the application server may be configured to run an application that accesses the websites to collect such data. For example, the application may include an application program interface (API) that interfaces with a third-party dynamic number insertion system that inserts telephone call tracking code in the panelists' websites. Dynamic number insertion is a technology known in the art that inserts a different and unique telephone contact number into a website that corresponds to the source of the contact, such that a call to that telephone number can immediately be associated with a specific advertising site. For example, as illustrated in FIG. 2, an Internet user who accesses the website from Google will see a telephone contact number that will identify Google as the source of the contact, while an Internet-user who accesses the website from Yahoo will see a different contact number that will identify Yahoo as the source of the contact, and so on.

In combination with dynamic number insertion, the application program may also add tracking code to the website, as illustrated in FIG. 2, to record click, conversion, metadata and source data. Click data captures the number of times the website is accessed (also known as the number of visits). Conversion data records the number of times that clicks result in actual contacts or other desired customer action (e.g., telephone, web form completion or email contacts), metadata includes search keywords, directory listing service categories, or other targeting parameters, and source data identifies the advertising site or search engine from whence the impression was sourced. These data may be converted to other well-known Internet advertising metrics such as contacts per thousand impressions (CPM), click-thru rate (CTR), conversion rate (CR), and average actions per month for any particular type of Internet advertisement. Other metrics may also be used. For example, metrics such as available impressions per month, available conversions per month, and so on, may be used.

Once the websites of the representative panel members are instrumented, the application server accesses a number of advertising sites or networks through manual user interfaces or via API's provided and/or specified by the advertising entities, and sets up ad campaigns for the instrumented websites programmatically.

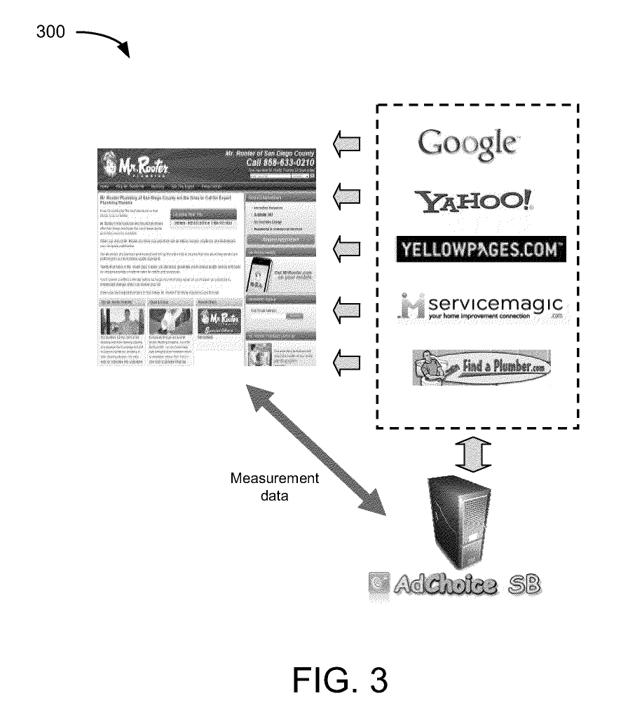

As illustrated in FIG. 3, the application server subsequently runs an application that monitors the instrumented websites and extracts the aforementioned data. The application also accesses the relevant advertising entities through the aforementioned APIs to download additional campaign data such as cost and impressions. The data is used to build a database that includes the campaign performance data as described above, organized into a business category-specific format. The campaign performance data is then analyzed by a statistical analysis engine (e.g., a statistical analysis application) that operates on the database to generate statistically significant ad campaign performance statistics. The campaign performance data is also used to develop an optimized targeting library, which is also organized into a business category-specific format. The optimized targeting library contains a set of “targeting settings templates” that describe what targeting settings to use for a given business category and ad network/site. For example, a campaign on Google may use a certain set of keywords, a certain geographic area, and a certain keyword bid price, along with a predefined set of ad text templates associated with the keywords or other targeting settings. A campaign on Yellowpages.com may use a certain set of business sub-categories such as “general dentistry, cosmetic dentistry, periodontal dentistry”, etc. A campaign on Facebook may use a set of user interest categories such as “family and parenting” or “auto enthusiasts”. The targeting library templates are created by starting with a template created “manually” (i.e. using well known industry practices), then validating the targeting using the campaign performance data (e.g., if certain keywords or other settings perform poorly, they are dropped from the template, leaving an “optimized” template that can be used for future campaigns. The campaign performance data is referenced in the creation of the optimized targeting settings.

The statistical analysis engine may be configured to normalize campaign performance data with respect to frequency. For example, a Google ad for one panel member in a representative business category may generate a thousand clicks, while a Google ad for another panel member in the same business category may generate only 100 clicks, as a result of different geographic locations or other factors. Without normalization, the Google response data for the first panel member would swamp the data for the second, resulting in a biased analysis. Therefore, according to one embodiment of the invention, the statistical analysis engine computes a mean response statistic for each Internet advertisement site, and then computes a mean of means that equalizes the weights of each search engine.

By tracking and analyzing real results from sample panels over a wide range of business categories and geographical areas and associating performance factors such as population density and the use of an optimized website, the system develops a database that can be used to predict the most effective online advertising campaign for any targeted business, and to automate the creation of high-performing ad campaigns for such a business.

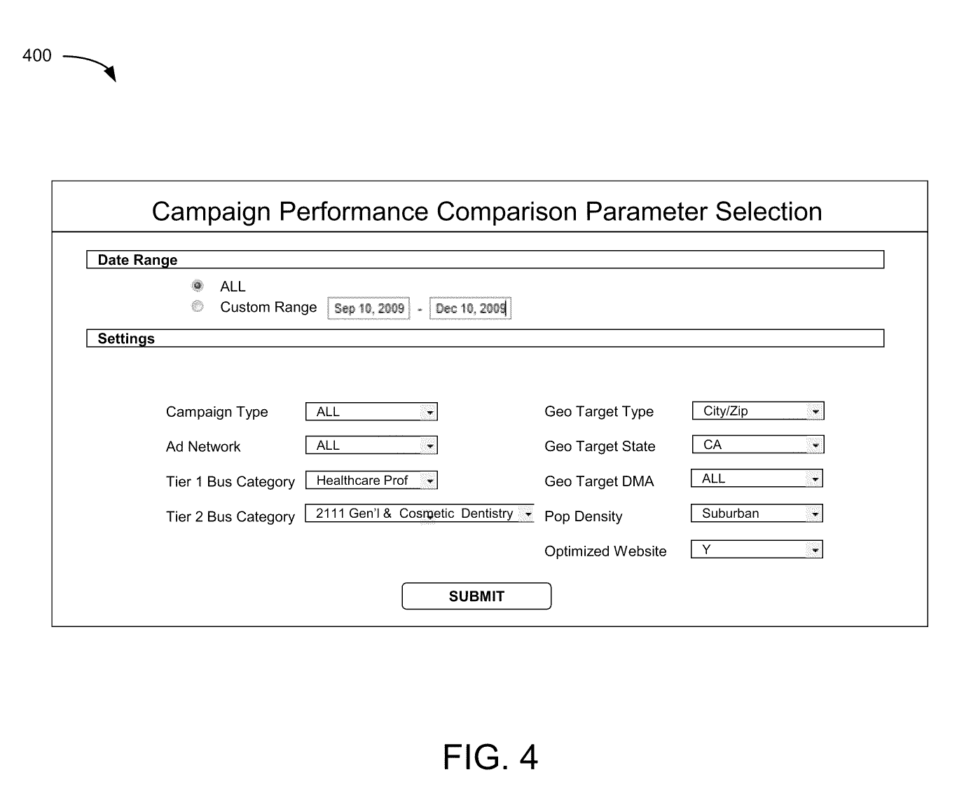

FIG. 4 is an exemplary screen that may be seen in a web browser by a user of the system who wants to select an Internet ad campaign. In FIG. 4, the user is provided with the option of selecting a business category using a pre-coded business category as well as additional selection criteria such as geographic area, population density of the subject advertiser's location, and whether the subject advertiser will utilize a website that conforms to a predefined template that is optimized for internet advertising.

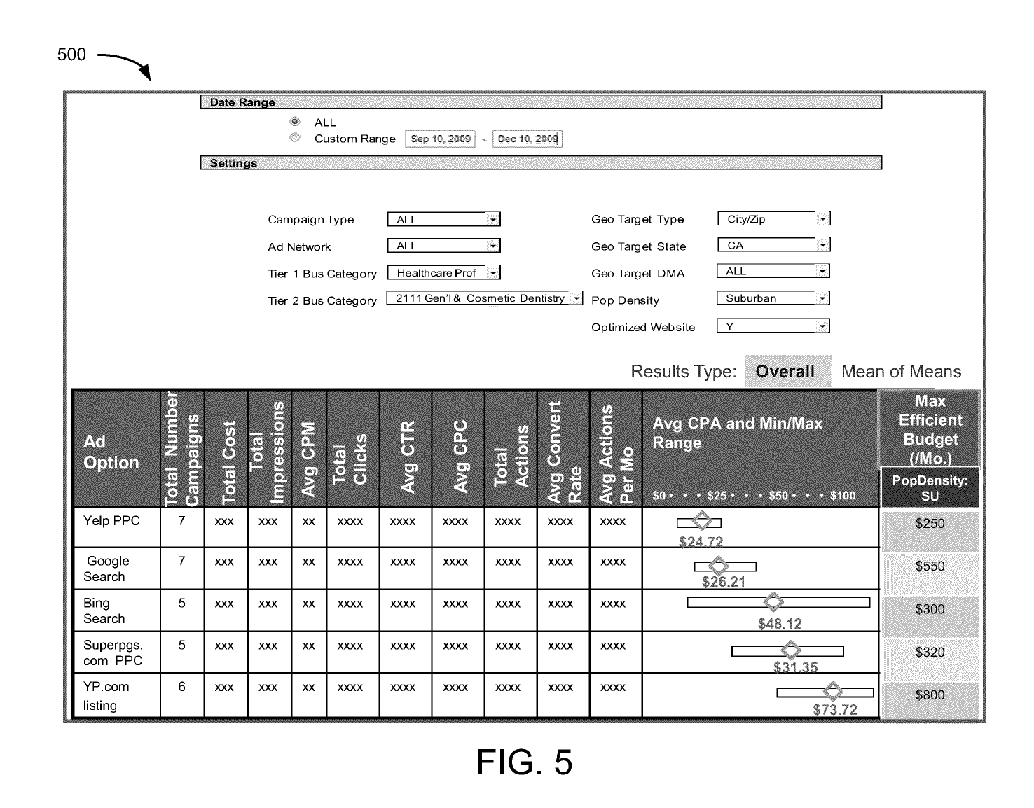

After selecting a business category and other selection criteria, the user may be presented with a campaign performance comparison screen, as illustrated in FIG. 5, where the aggregated performance metrics for a variety of advertising options are displayed. For each advertising option, the campaign performance comparison displays expected values of the cost per 1000 impressions (CPM), the click-thru rate (CTR), the average conversion rate, the average conversions per month, the type of campaign supported by each advertising network (e.g., flat rate time or pay per click), the maximum efficient budgets for the respective ad options, and average cost per action (CPA) for each advertising option, where an action is defined as a desired response (e.g., a telephone call or an email) to an online advertisement. The average cost per action may be illustrated through both an overall average value as well as a range illustrating the lowest to highest values, to enable a user to evaluate the relative range of potential outcomes.

The leftmost column in FIG. 5 identifies the advertising networks/sites, where the numbers in parentheses following each listed advertising network/site identifies the total number of campaigns in the database matching the General and Cosmetic Dentistry query. For example, there are 7 campaigns on Yelp PPC for this business category in the state of California. This information can be useful in estimating statistical significance of the results presented. In the next column of FIG. 5, Total Cost is the total cost of all campaigns shown in the results for this ad option. In the next column of FIG. 5, Total Impressions is the total number of impressions measured. An “impression” is defined as each time an ad appears to a user on an advertising web site. In the next column of FIG. 5, Average CPM is the total cost divided by total impressions in thousands. In the next column of FIG. 5, Total Clicks is the total number of times a user clicked on an advertisement for the campaigns shown. In the next column of FIG. 5, Average CTR is the total clicks on advertisements divided by total impressions. In the next column of FIG. 5, Average CPC is the average cost per click or total cost divided by the total number of clicks. In the next column of FIG. 5, Total Actions is the total number of designated customer actions that were triggered by the campaigns shown. Examples of customer actions that are designated in system 100 to be tracked may vary by the type of business and may include a phone call, email contact or completing an online form, or other actions for different types of businesses. In the next column of FIG. 5, Average Conversion Rate is the total number of actions (also called “conversions”) divided by total number of clicks. In the next column of FIG. 5, Average Actions Per Month is the average number of designated actions per campaign that were obtained from the campaigns shown. This figure may be useful in estimating the expected number of desired customer actions may be obtained from the ad options being evaluated. In the next column of FIG. 5, Average CPA is the total cost divided by total designated actions. The Minimum and Maximum CPA Range is the range of highest to lowest Average CPA values obtained from the campaigns shown. The Maximum Efficient Budget is the average of the maximum efficient budget values for the campaigns shown. Maximum efficient budget represents the maximum amount that can be cost-effectively spent by an advertiser in an area of given population density for a particular advertising option. The maximum efficient budget is derived by measuring the amount actually spent with an unlimited budget on each option within each population density category, such as rural, suburban, and urban, using a standardized campaign settings template that defines campaign characteristics such as geographic radius, a pay-per-click bid price, and keywords or other parameters targeted in the campaign. There are two sets of numbers that can be shown for each query: 1) the Overall Average (non-weight-adjusted) and the Mean of Means (weight-adjusted). The user may select which set to display by means of a “toggle” selection in the user interface.

A user, provided with this comparative data, may then evaluate the relative performance of various ad options in order to select the best options or eliminate options that fail to meet necessary criteria.

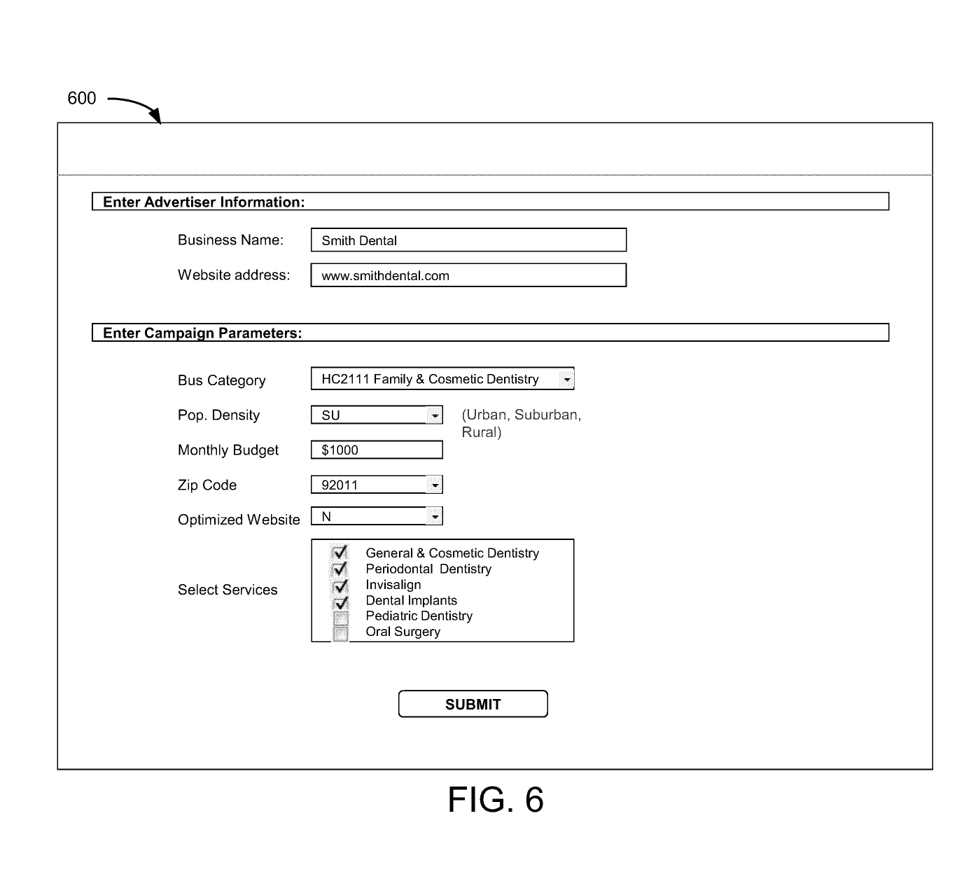

FIG. 6 illustrates an exemplary user interface which may be used to generate an optimized campaign for a business in a specified category and a specified geographic area, and for a specified budget, which optimizes the advertiser's results by allocating the budget to the most efficient ad options based on his conditions. As illustrated in FIG. 6, the user enters basic information about the business such as the business name and the website address, along with campaign parameters including the business category, population density of the business' geographic location, the desired monthly advertising budget, the geographic location of the business as designated by a zip code or similar designation, and whether the business will refer clicks from the campaign to a website that has been optimized for internet advertising in accordance with a predefined website template. Upon submitting these selection parameters, the system calculates and presents an optimized campaign which (i) identifies the best performing advertising options, within the criteria specified, in priority order based on the lowest cost per action, and, (ii) allocates the specified budget to the top performing options in priority order until the budget is fully allocated, utilizing the Maximum Efficient Budget value for each designated ad option, derived from values contained in the system database. For example, if the top performing options for a given set of parameters indicate Maximum Efficient Budget Values of $250 for Option 1, $550 for Option 2, and $300 for Option 3, where Options 1, 2 and 3 represent the best performing options respectively, and the designated total budget is $1000, the system will allocate $250 to Option 1, then $550 to Option 2, then $200 to Option 3 (or the remainder of the budget) for a total advertising budget of $1000.

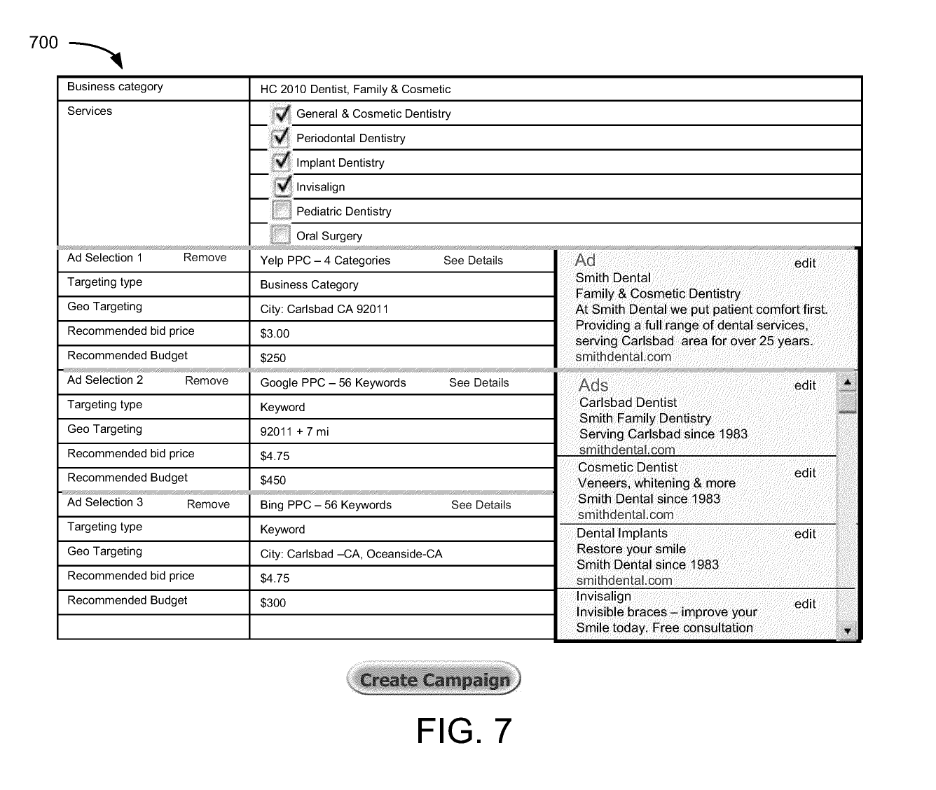

As illustrated in FIG. 7, the system may also apply and display a predefined campaign targeting settings template for each selected ad option, which defines the targeting settings for each respective ad option including business categories where appropriate, search keywords, pay-per-click bid price, geographic targeting, and predefined ad text or images. Campaign settings are assigned based on the corresponding templates contained in the system's Optimized Targeting Library. As shown in FIG. 7, the user can verify the selected advertising option and may remove an option by clicking the “Remove” link.

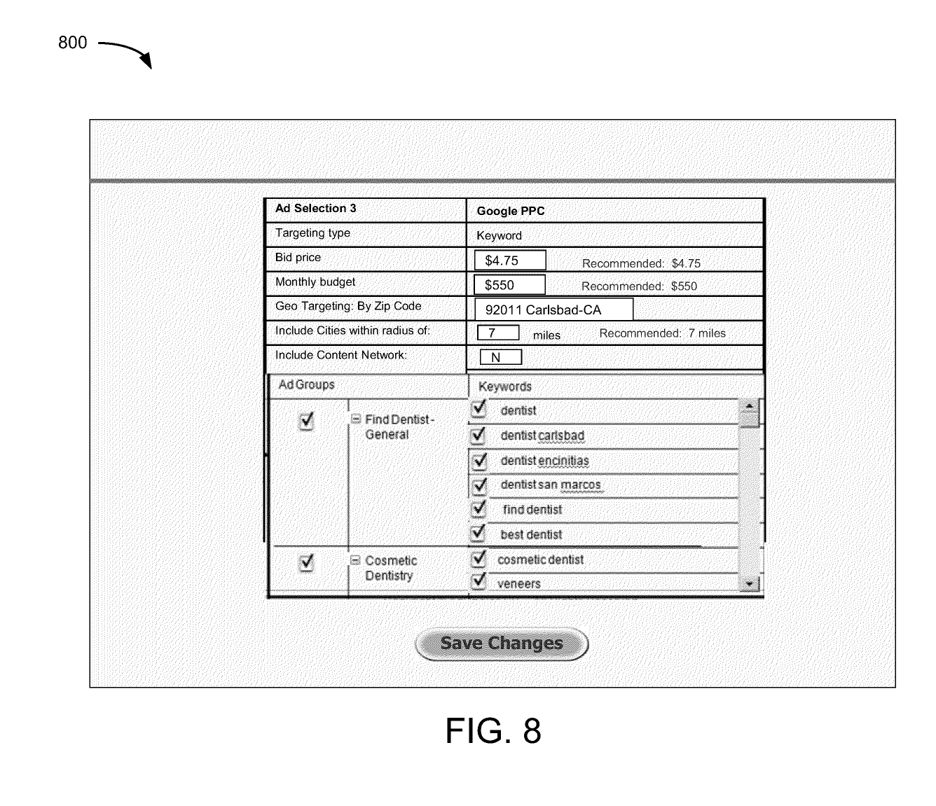

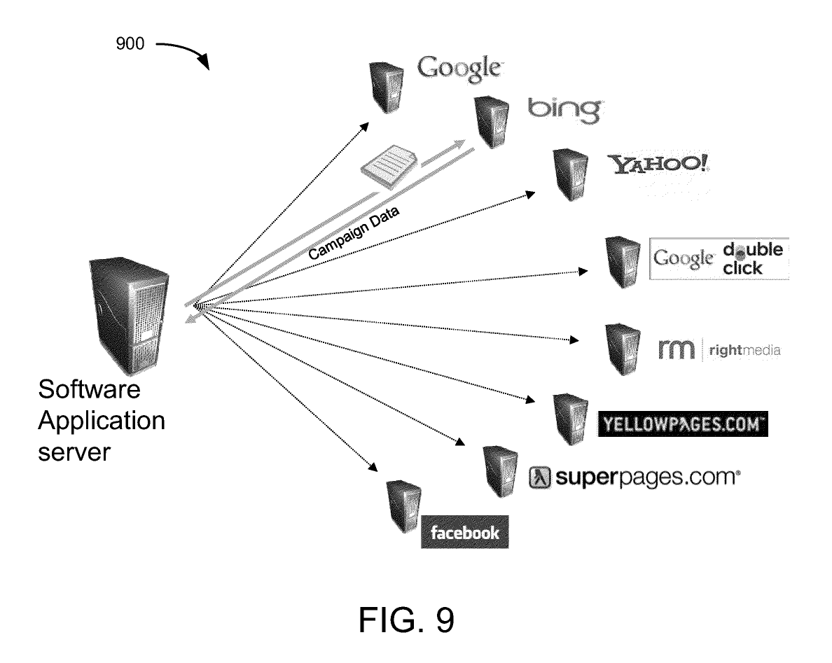

The user may also review the details of the campaign targeting settings by selecting the “See Details” link illustrated in FIG. 7, whereby he may be presented with a detailed view of the settings, as illustrated in FIG. 8, including a list of predefined campaign settings such as keywords or directory listing categories that will link online searches to the user's ad in the selected advertising network and, ultimately, to the user's website, the ad text and/or images that will appear in the advertiser's ad campaigns, the bid price for the keywords, and the geographic targeting that will be utilized for this component of the campaign. The user may either confirm or edit these settings. In response to a “Create Campaign” command, the system creates a campaign record containing the specified settings and the application server uploads the ad campaign components to the selected advertising networks and websites, using the aforementioned APIs, as illustrated conceptually by FIG. 9.

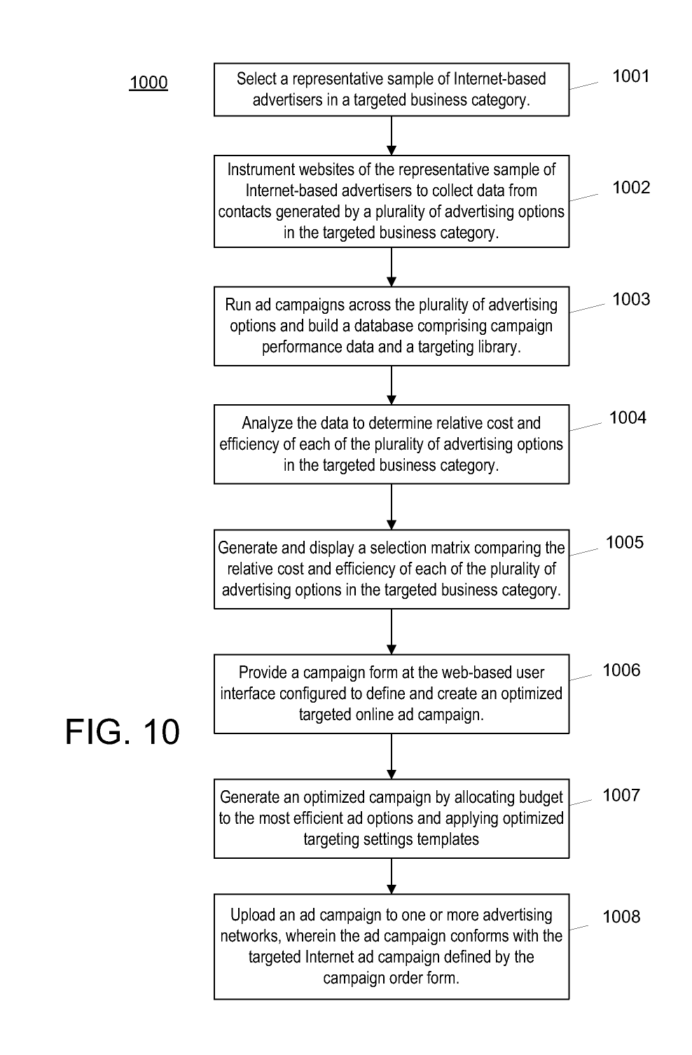

FIG. 10 is a flowchart 1000 illustrating a method according to one embodiment of the invention. In operation 1001, a representative panel of Internet-based advertisers in a targeted business category is selected. In operation 1002, the websites of the representative sample of Internet-based advertisers is instrumented to collect data from contacts generated by a number of advertising options in the targeted business category. In operation 1003, ad campaigns are run across the plurality of advertising options, and a database is developed that includes campaign performance data and a targeting library. In operation 1004, the data is analyzed to determine the relative cost and efficiency of each of the plurality of advertising options in the targeted business. In operation 1005, a selection matrix is generated and displayed that compares the relative cost and efficiency of each of the plurality of advertising options. In operation 1006, a campaign generation form is provided at a web-based user interface that is configured to define and create an optimized online ad campaign. In operation 1007, an optimized campaign is generated by allocating budget to the most efficient ad options and applying optimized targeting settings templates. And, in operation 1008, the ad campaign is uploaded to one or more advertising sites or networks.

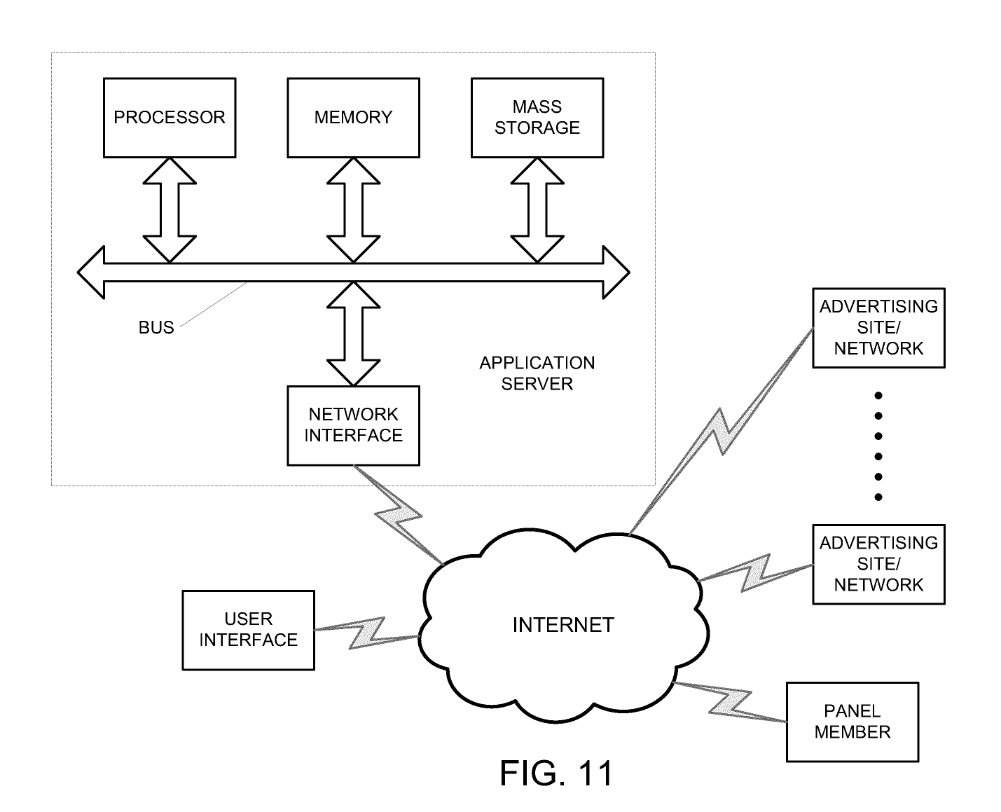

FIG. 11 is a block diagram of a system in one embodiment, illustrating components of an application server. In FIG. 11, the application server includes a processor, which may be a general purpose or special purpose processor; memory such as RAM, ROM, EPROM EEPROM, flash memory, SONOS memory or the like; mass storage such as magnetic or optical disc storage, for example; and a network interface device configured to implement a wired or wireless connection to a network, such as the Internet, for example.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

What is claimed is:

1. A method, comprising:
selecting a representative sample of Internet-based advertisers in a targeted business category;
instrumenting websites of the representative sample of Internet-based advertisers to collect data from desired customer actions generated by a plurality of advertising options in the targeted business category;
building a database comprising campaign performance data and a targeting library;
analyzing the data to determine relative cost and efficiency of each of the plurality of advertising options in the targeted business category;
generating and displaying a selection matrix comparing the relative cost and efficiency of each of the plurality of advertising options in the targeted business category; and
uploading an ad campaign to a selected advertising network.

2. The method of claim 1, further comprising executing a battery of campaigns on a plurality of advertising options using a standardized set of test conditions.

3. The method of claim 1, further comprising generating an optimized ad campaign by allocating a specified budget to the most cost-effective ad options.

4. The method of claim 1, wherein instrumenting the websites comprises:
adding tracking code configured to record click, conversion, metadata and source data, and
adding dynamic number insertion code to identify and track calls from each of the plurality of advertising options.

5. The method of claim 1, wherein the representative sample of Internet-based advertisers comprises a geographically limited sample defined by one or more of a ZIP code, a city, a metropolitan area, a state, a national region and the nation.

6. The method of claim 1, wherein the representative sample of Internet-based advertisers comprises a geographically limited sample defined by multiple population density categories.

7. The method of claim 1, wherein analyzing the data comprises calculating a mean of means to normalize weights of results from each of the plurality of advertising options.

8. The method of claim 1, wherein analyzing the data comprises deriving, for each of the plurality of advertising options, a maximum efficient budget defined as the average amount spent with an unlimited budget for a given advertising option in a given category of population density.

9. The method of claim 1, wherein generating the selection matrix comprises, for each of the plurality of advertising options, calculating one or more of an expected cost per desired action, a range of minimum to maximum cost per desired customer action, an expected cost per impression, an expected cost-per-click, an expected click-through rate, an expected conversion rate, an expected number of actions per unit time and an expected maximum efficient budget, the maximum efficient budget being defined as the average amount spent with an unlimited budget for a given advertising option in a given category of population density.

10. The method of claim 9, further comprising providing a web-based user interface (UI) configured to enable a user to select a business category, campaign targeting settings associated with the business category, and a geographical region for a targeted Internet advertising campaign.

11. The method of claim 10, further comprising providing a web-based user interface (UI) configured to display an ad campaign performance comparison, wherein, for each of the plurality of advertising options, a user is provided with one or more of the expected cost per desired customer action, the expected cost per impression, the expected cost-per-click, the expected click-through rate, the expected conversion rate, the expected number of actions per unit time and the expected maximum efficient budget per unit time.

12. The method of claim 11, further comprising providing a campaign generation form at the web-based user interface configured to define an optimized targeted Internet ad campaign.

13. The method of claim 12, further comprising generating an optimized campaign by allocation of the advertiser's budget utilizing of a set of maximum efficient budget values corresponding to each of a plurality of advertising options, such that the budget is allocated to the options corresponding to the lowest cost per desired customer action in sequence until the budget allocation is exhausted.

14. The method of claim 13, further comprising uploading an ad campaign to one or more advertising networks, wherein the ad campaign conforms with the optimized targeted Internet ad campaign defined by the campaign generation form.

15. The method of claim 1, wherein generating the selection matrix comprises, for each of the plurality of advertising options, calculating an expected cost per desired customer action, an expected cost per impression, an expected click-through rate, an expected ratio of actions to clicks or conversion rate, and an expected number of actions per unit time.

16. The method of claim 1, wherein generating the selection matrix comprises determining a maximum efficient budget, the maximum efficient budget representing the maximum amount that can be cost-effectively spent by an advertiser in an area of given population density for a particular advertising option, the maximum efficient budget being derived based on the amount actually spent with an unlimited budget on each option within each population density category using a standardized campaign settings template that defines campaign characteristics.

17. The method of claim 1, further comprising providing a web-based user interface (UI) configured to enable a user to compare and select an Internet advertising campaign based on a business category, type of advertising campaign, a geographical region, and a population density to target a selected set of potential customers, the web-based user interface (UI) being further configured to display an ad campaign performance comparison, where, for each of the plurality of advertising options, a user is provided with the expected cost per action, the expected cost per impression, the expected click-through rate, the expected conversion rate the expected number of actions per unit time and the expected maximum efficient budget per unit time.

18. The method of claim 1, further comprising
providing a campaign generation form configured to assist creation of an ad campaign, the campaign generation form being provided via a web-based user interface, the campaign generation form being configured to permit a user to enter campaign parameters including the business category, desired advertising budget, geographic location of the business, services provided by the business, whether the business will utilize an optimized website, and population density in the service area,
selecting advertising options on a cost-per-action basis and utilizing maximum efficient budget data, and
uploading an ad campaign to one or more advertising networks, where the ad campaign conforms with the campaign parameters defined by the combination of the campaign generation form entries and the standardized campaign targeting settings template.

19. A system, comprising:
a processor configured to execute application programs through one or more application program interfaces;
a memory coupled with the processor, configured to hold application program instructions and data;
a data storage device coupled with the processor, configured to store databases and application programs ; and
a network interface device coupled with the processor, configured to communicate over one or more networks, wherein
a first application program is configured to instrument websites of a representative sample of Internet-based advertisers in a targeted business category to collect data generated by a plurality of advertising options;
a second application program is configured to build a database from collected data, the database comprising performance data and a targeting library;
a third application program is configured to analyze the data to determine relative cost and efficiency of each of the plurality of advertising options in the targeted business category; and
a fourth application program is configured to generate and display a selection matrix in a web-based user interface, comparing the relative cost and efficiency of each of the plurality of advertising options in the targeted business category.

20. The system of claim 15, wherein a fifth application program is configured to generate an optimized advertising campaign which allocates a specified budget to the advertising options providing the lowest cost per desired customer action.

21. An article of manufacture, comprising a machine-readable medium having instructions thereon, which when read by a machine, cause the machine to perform operations comprising:
selecting a representative sample of Internet-based advertisers in a targeted business category;
instrumenting websites of the representative sample of Internet-based advertisers to collect data from desired customer actions generated by a plurality of advertising options in the targeted business category;
building a database comprising campaign performance data and a targeting library;
analyzing the data to determine relative cost and efficiency of each of the plurality of advertising options in the targeted business category; and
generating and displaying a selection matrix comparing the relative cost and efficiency of each of the plurality of advertising options in the targeted business category.

22. The article of claim 21, wherein the operations further comprise generating an optimized advertising campaign which allocates a specified budget to the advertising options providing the lowest cost per desired customer action.

23. A system, comprising:
means for selecting a representative sample of Internet-based advertisers in a targeted business category;
means for instrumenting websites of the representative sample of Internet-based advertisers to collect data from desired customer actions generated by a plurality of advertising options in the targeted business category;
means for building a database comprising campaign performance data and a targeting library;
means for analyzing the data to determine relative cost and efficiency of each of the plurality of advertising options in the targeted business category; and
means for generating and displaying a selection matrix comparing the relative cost and efficiency of each of the plurality of advertising options in the targeted business category.

24. The system of claim 23, further comprising means for generating an optimized internet advertising campaign by allocating a specified budget to the advertising options providing the lowest cost per desired customer action.
